(19) United States
(12) Patent Application Publication
(10) Pub. No.: US 2023/0210713 A1
(43) Pub. Date: Jul. 6, 2023

(54) MASSAGE APPARATUS COMPRISING FLEXIBLE RACK GEAR

(71) Applicant: BODYFRIEND CO., LTD., Seoul (KR)

(72) Inventors: Myeong Jin YOU, Seoul (KR); Deok Hyun KONG, Seoul (KR)

(21) Appl. No.: 17/927,253

(22) PCT Filed: May 18, 2021
(86) PCT No.: PCT/KR2021/006196

§ 371 Date: Nov. 22, 2022

(30) Foreign Application Priority Data
May 22, 2020 (KR) 10-2020-0061300

(51) Int. Cl. A61H 15/00; F16H 19/06

(52) U.S. Cl. CPC A61H 15/0078; F16H 19/0645; A61H 2201/0149; A61H 2201/1481; F16H 2019/0613

(57) ABSTRACT

The present disclosure relates to a massage apparatus comprising a flexible rack gear. A main frame comprises: a rack gear belt comprising a rack gear which is for moving a massage module, has a plurality of holes formed therein, is formed from a flexible material, and extends along a buttocks frame and a back frame comprised in the main frame, wherein the rack gear comprises a buttocks rack gear and a back rack gear and is formed without a connecting portion for connecting the buttocks rack gear and back rack gear; and a rack gear support part which is positioned below the rack gear belt to support the rack gear belt, and is formed from a flexible material. The massage module comprises: a pinion gear which comprises pinion gear teeth engaging the rack gear belt, and moves the massage module along the rack gear by means of rotation transmitted from an actuator; a connecting link for connecting the pinion gear and a guide roller; and the guide roller which rotates in contact with the rack gear support part by means of the movement of the pinion gear, and prevents the massage module from shaking.

### TECHNICAL FIELD

The present invention relates to a massage apparatus comprising a flexible rack gear and an operating method thereof.

### BACKGROUND ART

Massage is a medical adjuvant therapy for controlling the modulation of the body of a user helping blood circulation, and relieving fatigue of the user by applying various types of mechanical stimulation to a portion of the body, such as massaging, pressing, pulling, tapping, or moving a portion of the body of the user, helping blood circulation.

The growth in a massage demand caused an increase in demand for massage apparatuses or massage devices, which provide an artificial massage function, because of economic feasibility and temporal reasons. That is, as the demand for relieving fatigue or stress is increased while loosening the agglomerated muscles through massage, various mechanical massage apparatuses for time and cost efficiencies are being released. Any type of instruments, devices, or apparatuses for performing massage without a massagist is referred to as a massage apparatus.

Recently, a massage apparatus including a massage chair of which the backrest is completely reclined has been released. The massage apparatus includes a massage module therein to provide massage to a user. The module provides massage to the user while moving from the legs to the back of the user. In order to move the massage module, the massage apparatus includes a rack gear, and the massage module includes a pinion gear. However, in a case in which the backrest is reclined or is erect, since an interval between the gear teeth of the rack gear provided in the massage apparatus is changed, the massage module may not move normally. In order to solve such a problem, various studies have been made.

### DISCLOSURE

### Technical Problem

Accordingly, the present invention has been made in view of the above-mentioned problems occurring in the related art, and it is an object of the present invention to provide a massage apparatus comprising a flexible rack gear and an operating method thereof.

### Technical Solution

To accomplish the above-mentioned objects, according to the present invention, there is provided a massage apparatus including: a rack gear included in a main frame to move a massage module, wherein the rack gear includes: a buttock rack gear and a back rack gear without a connection unit for connecting the buttock rack gear and back rack gear; a rack gear belt having a plurality of holes, made of a flexible material, and extending along a buttock frame and a back frame included in the main frame; and a rack gear support positioned below the rack gear belt to support the rack gear belt and made of a flexible material. The massage module includes: a pinion gear having teeth engaging the rack gear belt, and moving the massage module along the rack gear by rotation received from an actuator; a connection link for connecting the pinion gear and a guide roller; and a guide roller rotating in contact with the rack gear support by the movement of the pinion gear, and preventing the massage module from shaking.

The rack gear support of the massage apparatus according to an embodiment of the present invention includes: a support core supporting the rack gear belt above or below; and a side plate being perpendicular to the support core, preventing the support core from being bent, and formed on at least a portion of the rack gear support.

The support core of the massage apparatus according to an embodiment of the present invention includes: a gear tooth movement groove formed toward the pinion gear side so that teeth of the pinion gear do not get in contact with the rack gear support; and at least one hook groove to which at least one fixing hook formed on the rack gear belt is coupled so that the rack gear belt can be fixed to the rack gear support.

The pinion gear of the massage apparatus according to an embodiment of the present invention includes: a driving shaft insertion groove into which a driving shaft for transmitting rotation of the actuator is inserted; a link insertion portion inserted into a connection link; and a gear head extending from the link insertion portion in a longitudinal direction of the driving shaft and having teeth formed on at least a portion of the outer circumferential surface thereof.

According to an embodiment of the present invention, a portion of the gear head where the teeth of the pinion gear are not formed at both sides of the tooth of the pinion gear touches a portion of the rack gear belt where at least one hole is not formed, and the pinion gear is supported from the rack gear belt.

According to an embodiment of the present invention, a portion of the gear head where the teeth of the pinion gear are not formed at both sides of the tooth of the pinion gear is surface-treated to increase a frictional force.

One or more guide rollers of the massage apparatus according to an embodiment of the present invention are connected to the pinion gear by the connection link.

According to an embodiment of the present invention, the shape of the plurality of holes formed in the rack gear belt is any one of a rectangular shape, an oval shape, and a circular shape, and at least one of the plurality of holes is formed in a width direction of the rack gear belt, and the plurality of holes are continuously formed at a predetermined pitch in a longitudinal direction of the rack gear belt.

The rack gear belt of the massage apparatus according to an embodiment of the present invention is made of spring steel.

According to an embodiment of the present invention, the massage apparatus further includes: an additional rack gear belt which is positioned below the rack gear support part, has a plurality of holes, is made of a flexible material, and extends along the buttock frame and the back frame included in the main frame. At least a portion of the guide roller has gear teeth to be engaged with the additional rack gear belt, and the guide roller moves the massage module along the rack gear by rotation received from the actuator, and the rack gear support includes a gear tooth movement groove formed toward the guide roller so as not to get in contact with the gear teeth formed on the guide roller.

The rack gear support of the massage apparatus according to an embodiment of the present invention includes an angle change unit to change an angle of the back rack gear with respect to the buttock rack gear, and the angle change unit includes a first sub-component, a second sub-component, and a change unit rotating shaft passing through both the first sub-component and the second sub-component.

The side plate of the massage apparatus according to an embodiment of the present invention is not formed between the buttock rack gear and the back rack gear.

In addition, a program for implementing an operating method of the massage apparatus described above may be recorded in a computer-readable recording medium.

### Advantageous Effects

The massage apparatus according to the present invention provides the massage module capable of freely moving between the buttock rack gear and the back rack gear even if the backrest is reclined or the posture of the massage chair is changed.

The effects of the present disclosure are not limited to the above-mentioned effects, and other effects, which are not specifically mentioned herein, will be clearly understood by those skilled in the art from the following description.

### DESCRIPTION OF DRAWINGS

FIG. 1 is a view for depicting a massage apparatus according to an embodiment of the present invention.

FIG. 2 is a view for depicting a main frame according to an embodiment of the present invention.

FIG. 3 is a view for depicting a main frame according to an embodiment of the present invention.

FIG. 4 is a view illustrating a massage apparatus according to an embodiment of the present invention.

FIG. 5 is a view illustrating an external device capable of communicating with a massage apparatus according to an embodiment of the present invention.

FIG. 6 is a view illustrating a massage apparatus according to an embodiment of the present invention.

FIG. 7 is a view illustrating a rack gear belt included in a rack gear according to an embodiment of the present invention.

FIG. 8 is a view illustrating a rack gear belt included in a rack gear according to an embodiment of the present invention.

FIG. 9 is a view illustrating a rack gear support included in a rack gear according to an embodiment of the present invention.

FIG. 10 is a view illustrating an angle change unit according to an embodiment of the present invention.

FIG. 11 is a view illustrating a rack gear according to an embodiment of the present invention.

FIG. 12 illustrates a pinion gear included in a massage module according to an embodiment of the present invention.

FIG. 13 is a view for depicting a pinion gear included in a massage module according to an embodiment of the present invention.

FIG. 14 is a view for depicting a pinion gear according to an embodiment of the present invention.

FIG. 15 is a view for depicting a pinion gear according to an embodiment of the present invention.

FIG. 16 is a view illustrating a pinion gear and a guide roller of a massage module according to an embodiment of the present invention.

FIG. 17 is a view for depicting a massage module according to an embodiment of the present invention.

### BEST MODE

Provided is a massage apparatus including: a rack gear included in a main frame to move a massage module, wherein the rack gear includes: a buttock rack gear and a back rack gear without a connection unit for connecting the buttock rack gear and back rack gear; a rack gear belt having a plurality of holes, made of a flexible material, and extending along a buttock frame and a back frame included in the main frame; and a rack gear support positioned below the rack gear belt to support the rack gear belt and made of a flexible material, wherein the massage module includes: a pinion gear having teeth engaging the rack gear belt, and moving the massage module along the rack gear by rotation received from an actuator; a connection link for connecting the pinion gear and a guide roller; and a guide roller rotating in contact with the rack gear support by the movement of the pinion gear, and preventing the massage module from shaking.

### MODE FOR INVENTION

Advantages and features of the present invention and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention.

Terms used herein will be briefly described, and the disclosed embodiments will be described in detail.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

The singular forms of the components may be understood into the plural forms unless otherwise specifically stated in the context. Furthermore, the plural forms may include singular forms unless otherwise specifically stated in the context.

In the entire specification of the present invention, when a certain part “includes” a certain component, other components are not excluded unless explicitly described otherwise, and other components may in fact be included.

The term, “unit”, used in the present invention means a software element or a hardware element, and the “unit” performs some roles. However, the term, “unit”, is not limited to software or hardware. The “unit” may be configured in an addressable storage medium or may be configured to play one or more processors. Therefore, as an example, a “unit” includes elements, such as software elements, object-oriented software elements, class elements, and task elements, processes, functions, attributes, procedures, subroutines, segments of program codes, drivers, firmware, microcode, circuits, data, databases, data structures, tables, arrays, and variables. Functions provided within the elements and “units” may be combined with a smaller number of elements and “units” or may be further divided into additional elements and “units”.

According to an embodiment of the present invention, the “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and the like. In some environments, a “processor” may refer to an application specific integrated circuit (ASIC), a programmable logic device (PLD), a field programmable gate array (FPGA), or the like. The term “processor” may refer to a combination of processing devices, such as a combination of a DSP genome and a microprocessor, a combination of a plurality of microprocessors, a combination of one or more microprocessors in combination with a DSP couple core, or a combination of any other such configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erase-programmable read-only memory (EPROM ACL), electrically erasable PROM (EEPROM), flash memory, magnetic or optical data storage, registers, and the like. Memory is referred to as being in electronic communication with the processor if the processor can read information from, and/or write information to, the memory. The memory integrated in the processor is in electronic communication with the processor.

In the present specification, an actuator refers to a configuration capable of providing a driving force. For example, the actuator may include a motor, a linear motor, an electronic motor, a DC motor, an AC motor, a linear actuator, an electric actuator, and the like, but is not limited thereto.

In the present specification, according to an embodiment, a massage apparatus may refer to a massage apparatus including a body massage unit and a leg massage unit. In addition, according to another embodiment, a body massage unit 2100 and a leg massage unit 2300 may be provided as separate devices (for example, a body massage apparatus and a leg massage apparatus), and the massage apparatus may refer to a body massage apparatus or a leg massage apparatus.

Hereinafter, embodiments of the present invention will be described in detail with reference to the accompanying drawings so as to be easily carried out by a person skilled in the art to which the present invention pertains. In addition, in order to clearly describe the present invention, portions irrelevant to the description will be omitted.

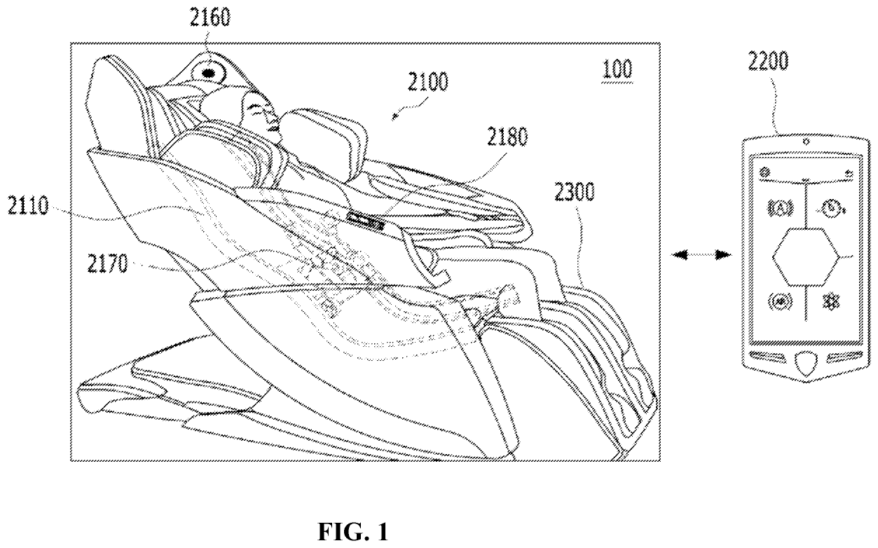

FIG. 1 is a view for depicting a massage apparatus according to an embodiment of the present invention.

The massage apparatus 100 according to an embodiment of the present invention may include a body massage unit 2100 for forming an area for accommodating at least a portion of the body of a user and massaging the body of the user, and a leg massage unit 2300 for massaging the user's legs.

The body massage unit 2100 may provide massage to at least a portion of the body of the user. The body massage unit 2100 may include a massage module 2170 for providing a massage function to at least a portion of the body of the user, an audio output module 2160 for providing an audio output of an arbitrary form to the user, a main frame 2110 constituting a framework of the body massage unit 2100, and a user input unit 2180 for receiving any form of input from the user.

The components included in the body massage unit 2100 described above are merely exemplary embodiments, and the body massage unit 2100 may include various configurations besides the above described configuration.

In addition, the shape and structure of the massage apparatus 100 illustrated in FIG. 1 are merely exemplary, and various types of massage apparatuses 100 may also be included within the scope of the present invention unless departing from the scope of the present invention defined by the claims of the present invention.

The body massage unit 2100 may form a space for accommodating the user. The body massage unit 2100 may have a space corresponding to the shape of the body of the user. For example, as illustrated in FIG. 1, the body massage unit 2100 may be implemented as a seating type capable of accommodating the whole body or a portion of the body of the user.

A portion of the body massage unit 2100, which gets in contact with the ground, may include any material or any member (for example, an anti-slip pad or the like) for increasing a frictional force, and may include a wheel for enhancing mobility of the massage apparatus 100.

At least a portion of the body massage unit 2100 may slide. For example, in a case in which the body massage unit 2100 starts massage, at least a portion of the body massage unit 2100 may slide forward. In addition, the body massage unit 2100 may be tilted backward. As a result, the body massage unit 2100 may provide massage while being tilted backward.

According to an embodiment of the present invention, the massage apparatus 100 may include at least one air cell (not illustrated). The air cell may be located at a shoulder portion, a pelvis portion, arm massage units, a leg massage unit 2300, and the like, but is not limited thereto, and may be disposed in various portions of the massage apparatus 100.

The massage apparatus 100 may include an air supply unit, and the air supply unit may inflate the air cell by supplying air to the air cell. The air supply unit may be located inside the body massage unit 2100 and may be located in the leg massage unit 2300. Additionally, the air supply unit may be located outside the massage apparatus 100.

The leg massage unit 2300 may massage the user's legs. For example, the leg massage unit 2300 may include a calf massage unit for massaging the calves of the user and/or a foot massage unit for massaging the user's feet.

The leg massage unit 2300 may adjust the length according to the body characteristics of the user. For example, in a case in which a user who is tall uses the massage apparatus 100, it is necessary to lengthen the leg massage unit 2300 since the user has long calves. Moreover, in a case in which a user who is short uses the massage apparatus 100, it is necessary to shorten the leg massage unit 2300 since the user has short calves.

The massage module 2170 may be provided inside the body massage unit 2100 to provide a mechanical stimulation to the user accommodated in the body massage unit 2100. As illustrated in FIG. 1, the massage module 2170 may move along a main frame 2110 provided inside the body massage unit 2100.

For example, a rack gear may be provided in the main frame 2110 of the body massage unit 2100. The massage module 2170 may provide dynamic stimulation to various parts of the body of the user while moving along the rack gear. The massage module 2170 may include a ball massage unit or a roller massage unit, but is not limited thereto.

The main frame 2110 constitutes a frame of an internal configuration of the body massage unit 2100, and may be formed of a metal material, a plastic material, or the like. For example, the main frame 2110 may be made of iron, an alloy, steel, or the like, but is not limited thereto, and may be made with various rigid materials.

According to an embodiment of the present invention, the massage apparatus 100 may include an audio output module 2160. The audio output module 2160 may be provided at various positions. For example, the audio output module 2160 may include a plurality of output units, such as an upper audio output unit disposed on an upper end of a seat portion getting in contact with the user, a front audio output unit attached to a front end of the left and right arm massage units of the seat portion, and/or a rear audio output units attached to rear ends of the arm massage units, but is not limited thereto. In this case, the audio output module 2160 may provide a stereoscopic sound, such as a 5.1 channel, but is not limited thereto.

According to an embodiment of the disclosure, the user may control the massage apparatus 100 by using a massage apparatus control device 2200. The massage apparatus control device 2200 may be connected to the massage apparatus 100 through wired communication and/or wireless communication.

The massage apparatus control device 2200 may include a remote controller, a cellular phone, a personal digital assistant (PDA), and the like, but is not limited thereto, and may include various electronic devices connectable to the massage apparatus 100 through wired or wireless communication.

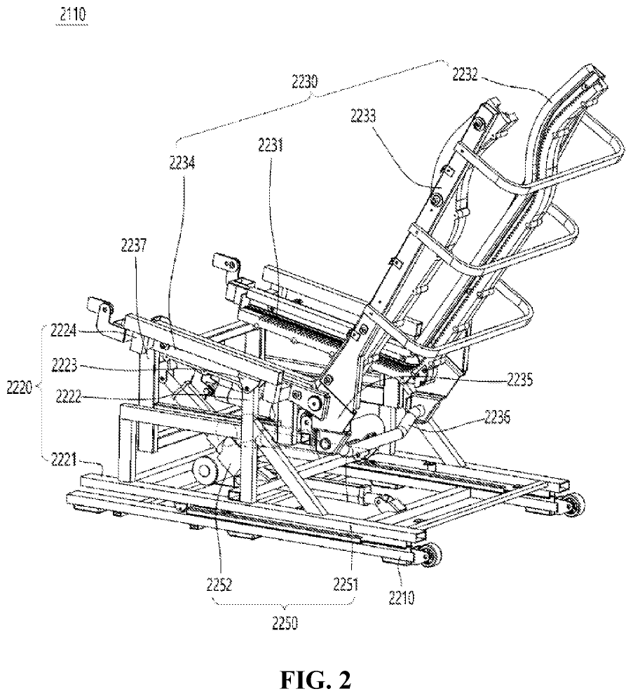

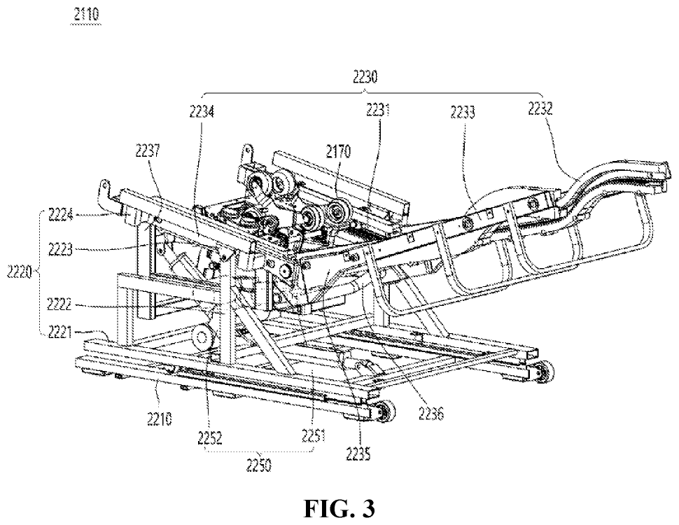

FIGS. 2 and 3 are views for depicting a main frame according to an embodiment of the present invention. Specifically, FIG. 3 is a view illustrating a state in which an angle of the back frame 2232 is changed.

According to an embodiment of the disclosure, the main frame 2110 may include at least one among a base frame 2210, a lower frame 2220, and an upper frame 2230. In addition, a frame actuator 2250 and the massage module 2170 may be disposed in the main frame 2110 according to an embodiment of the present invention.

The base frame 2210 may be disposed on the ground to stably support the massage apparatus 100. The base frame 2210 may be supported by the ground and may support the lower frame 2220 and the upper frame 2230. The base frame 2210 according to an embodiment may be relatively widely disposed to balance the center of gravity of the massage apparatus 100, but is not limited thereto.

The lower frame 2220 may support the upper frame 2230. The lower frame 2220 according to an embodiment may directly support the buttock frame 2231 of the upper frame 2230. The lower frame 2220 according to an embodiment may be disposed perpendicular to one side and the other side of the base frame 2210 to support the upper frame 2230, but is not limited thereto.

According to an embodiment of the present invention, the lower frame 2220 may move along the base frame 2210. For example, the lower frame 2220 may slide forward or backward along the base frame 2210. Accordingly, the sliding movement of the body massage unit 2100 may be allowed.

Specifically, in order to allow movement of the lower frame 2220, a moving wheel may be provided beneath the lower frame 2220. In addition, a guide member capable of guiding the moving wheel may be provided on an upper portion of the base frame 2210. The moving wheel provided beneath the lower frame 2220 may move along the guide member provided on the base frame 2210, thereby allowing forward movement or backward movement.

According to another embodiment of the present invention, the lower frame 2220 and the base frame 2210 may not be separated to be formed integrally, and the lower frame 2220 may be fixed without moving along the base frame 2210. For example, the lower frame 2220 may be fixed without sliding forward or backward.

Specifically, the moving wheel may not be provided beneath the lower frame 2220, and a fixing member for fixing the lower frame 2220 and the base frame 2210 may be provided between the lower frame 2220 and the base frame 2210. In addition, the lower frame 2220 and the base frame 2210 may be integrally formed.

The lower frame 2220 according to an embodiment of the present invention may include at least one among a slide frame 2221, a support shaft frame 2222, a swing bracket 2223, and an upper and lower coupling frame 2224.

The slide frame 2221 may slide forward or backward along the base frame 2210. The slide frame 2221 may be disposed on the base frame 2210 to support the support shaft frame 2222.

The support shaft frame 2222 may serve as a support shaft for supporting the upper frame 2230. In addition, the entire upper frame 2230 of the main frame 2110 according to an embodiment of the present invention may move forward and backward, and in this case, the support shaft frame 2222 may serve as a central axis. One end of the support shaft frame 2222 may be coupled to the slide frame 2221, and the other end thereof may be coupled to the swing bracket 2223.

The swing bracket 2223 supports the upper frame 2230 and allows the upper frame 2230 to rotate around the support shaft frame 2222. An upper and lower portion coupling frame 2224 may be coupled to the upper surface of the swing bracket 2223. When one end and the other end of the upper and lower portion coupling frame 2224 move, the swing bracket 2223 may serve to maintain the balance of the upper and lower portion coupling frame 2224.

The cross section of the swing bracket 2223 according to an embodiment may have a triangular shape, but is not limited thereto. In a case in which the cross section of the swing bracket 2223 has a triangular shape, the support shaft frame 2222 may be inserted into a first vertex portion of the swing bracket 2223. In addition, although the coupling member simultaneously penetrates the first vertex portion of the swing bracket 2223 and the support shaft frame 2222, the swing bracket 2223 and the support shaft frame 2222 may be coupled, but the coupling method is not limited thereto. In this instance, a first bottom side portion (the upper surface of the swing bracket 2223) facing the first vertex of the swing bracket 2223 may be coupled to the upper and lower portion coupling frame 2224.

The upper and lower portion coupling frame 2224 may couple the lower frame 2220 and the upper frame 2230. A portion of the bottom surface of the upper and lower portion coupling frame 2224 according to an embodiment may be coupled to the swing bracket 2223. Furthermore, one end and the other end of the upper and lower portion coupling frame 2224 according to an embodiment may be coupled to the upper frame 2230. More specifically, one end and the other end of the upper and lower portion coupling frame 2224 according to an embodiment may be coupled to a side connection frame 2234 of the upper frame 2230. The upper and lower portion coupling frame 2224 may also move depending on the movement of the side connection frame 2234.

A frame actuator 2250 may be disposed on the lower frame 2220 according to an embodiment of the present invention.

The frame actuator 2250 may provide a driving force for moving at least one among a rear connection frame 2236, a lower frame 3200, an upper frame 3300, and a leg frame (not shown) of the leg massage unit. The frame actuator 3250 according to an embodiment of the present invention may include at least one among a back angle actuator 3251, a swing motion actuator 3252, a sliding actuator (not shown), and a leg angle actuator (not shown).

The back angle actuator 3251 may adjust the angle of the back frame 200. One side of the back angle actuator 3251 according to an embodiment may be fixed to the lower frame 3200, and the other side thereof may be fixed to the rear connection frame 2236. The back angle actuator 2251 may adjust the angle of the back frame 2232 by moving the rear connection frame 2236 forward and backward.

The swing motion actuator 2252 may adjust an angle of the upper frame 2230. One side of the swing motion actuator 2252 according to an embodiment may be fixed to the upper frame 2230, and the other side thereof may be fixed to the lower frame 2220. The swing motion actuator 2252 may adjust an angle of the entire upper frame 2230 by moving the upper frame 2230 forward and backward.

The sliding actuator (not shown) may slidably move the body massage unit 2100. One side of the sliding actuator (not shown) according to an embodiment may be fixed to the base frame 2210, and the other side thereof may be fixed to the lower frame 2220. The sliding actuator (not shown) moves the lower frame 2220 forward and backward so that the lower frame 2220 can slide forward or backward along the base frame 2210, thereby allowing the body massage unit 2100 to slide.

The leg angle actuator (not shown) may adjust the angle of the leg massage unit. One side of the leg angle actuator (not shown) according to an embodiment may be fixed to the upper frame 2230, and the other side thereof may be fixed to the leg frame (not shown). The leg angle actuator (not shown) may adjust the angle of the leg massage unit by moving the leg frame (not shown) forward and backward.

The upper frame 2230 may serve as a framework supporting the body of the user. The upper frame 2230 according to an embodiment may support the user's buttocks and back. The upper frame 2230 may be supported by the lower frame 2220. The massage module 2170 may be disposed on the upper frame 2230 to massage the user's body.

The upper frame 2230 according to an embodiment of the present invention may include at least one among the buttock frame 2231, the back frame 2232, an anti-transforming frame 2233, the side connection frame 2234, the connection bracket 2235, the rear connection frame 2236, and a front connection frame 2237.

The buttock frame 2231 may support the user's buttocks. The buttock frame 2231 may be formed in plural, and the plurality of buttock frames 2231 may face each other on both sides of the lower frame 2220. The buttock frames 2231 according to an embodiment may be formed separately from the back frame 2232. The buttock frames 2231 may be respectively provided with buttock rack gears.

The buttock rack gears are used to guide the movement of the massage module 2170, and may include a plurality of rack gear protrusions and a plurality of rack gear grooves. The buttock rack gears may be disposed at both sides of the buttock frames 2231 to face each other, and the massage module 2170 may move along the buttock rack gears. The buttock rack gear may be provided on the buttock frame 2231 as a separate member, or may be formed in a pattern shape on a portion of the buttock frame 2231.

The back frame 2232 may support the user's back. The back frame 2232 may be disposed adjacent to the buttock frame 2231. The back frames 2232 may be disposed at both sides of the lower frame 2220 to face each other. The back frame 2232 may be separated from the buttock frame 2231 and may move as a separate frame in order to allow a change in angle with the buttock frame 2231.

The back frame 2232 according to an embodiment may be formed in various shapes. For example, the back frame 2232 may be divided into an I frame, an S frame, or the like according to the form thereof, but is not limited thereto.

The I frame refers to a frame in which at least a portion of the back frame 2232 is formed in an “I” shape. The S frame refers to a frame in which at least a portion of the back frame 2232 has a curved shape like “S”. In a case in which the massage module 2170 is provided in the I frame, the massage module 2170 may move in a straight line along the I frame.

The back frame 2232 may be provided with back rack gears. The back rack gears may guide the movement of the massage module 2170, and may include a plurality of rack gear protrusions and a plurality of rack gear grooves. The back rack gears may be disposed at both sides of the back frame 2232 to face each other, and the massage module 2170 may move along the back rack gears. The back rack gears may be provided on the back frame 2232 as a separate member, or may be formed in a pattern shape in a portion of the back frame 200.

The buttock frame 2231 and the back frame 2232 according to an embodiment of the present invention may be formed as separate frames, and may be disposed to be adjacent to each other. An angle adjustment protrusion may be disposed at a lower portion of one end of the buttock frame 2231 or the back frame 2232 according to an embodiment of the present invention, and an angle adjustment guide having a protrusion insertion groove may be provided at a lower portion of one end of the buttock frame 2231 or the back frame 2232 on which the angle adjustment protrusion is not disposed. As the angle adjustment protrusion is inserted into the protrusion insertion groove of the angle adjustment guide, the buttock frame 2231 and the back frame 2232 may maintain a predetermined interval without being spaced apart from each other over the predetermined interval while the angle between the buttock frame 2231 and the back frame 2232 is adjusted.

The buttock frame 2231 and the back frame 2232 according to an embodiment of the present invention may be made of a plastic material or a metal material, but are not limited thereto. The buttock rack gear may be formed in a pattern shape on the buttock frame 2231 according to an embodiment of the present invention, and the back rack gear may be formed in a pattern shape on the back frame 2232. In this case, the buttock frame 2231 and the back frame 2232 may be made of a plastic material.

In a case in which the back frame 2232 is made of a plastic material, in order to prevent the back frame 2232 from being transformed or shaken, the anti-transforming frame 2233 may be disposed on a side portion of the back frame 2232 to support the back frame 2232. For example, the anti-transforming frame 2233 may be formed of iron, an alloy, steel, or the like, but is not limited thereto, and may be made with various rigid materials.

The side connection frame 2234 may fix the buttock frame 2231 to the lower frame 2220. One surface of the side connection frame 2234 according to an embodiment may be coupled to the buttock frame 2231, and the other surface of the side connection frame 2234 may be coupled to the lower frame 2220. More specifically, the side connection frame 2234 according to an embodiment may be coupled to the upper and lower portion coupling frame 2224 of the lower frame 2220.

The connection bracket 2235 may connect the anti-transforming frame 2233 and the side connection frame 2234. The connection bracket 2235 according to an embodiment may be formed in a triangular thin plate shape so that a first vertex portion may be coupled to the anti-transforming frame 2233, a second vertex portion may be coupled to the side connection frame 2234, and a third vertex portion may be coupled to the rear connection frame 2236, but is not limited thereto. The connection bracket 2235 may include a first connection bracket and a second connection bracket disposed on both sides of the lower frame 2220 to face each other.

Meanwhile, the connection bracket 2235 may be disposed separately from the anti-transforming frame 2233, but may be integrally formed by being extended from the anti-transforming frame 2233.

The rear connection frame 2236 may connect the back frame 2232 and the back angle actuator 2251. The rear connection frame 2236 may be connected to the back frame 2232 through the connection bracket 2235 and the anti-transforming frame 2233. Accordingly, in a case in which the rear connection frame 2236 is moved, the angle of the back frame 2232 may be adjusted. The rear connection frame 2236 may be connected to the back angle actuator 2251, and the back angle actuator 2251 may move the rear connection frame 2236 forward and backward, thereby adjusting the angle of the back frame 2232. The rear connection frame 2236 may be coupled to the third vertex portion of the connection bracket 2235, and may be coupled between a first connection bracket and a second connection bracket.

The front connection frame 2237 may connect the upper frame 2230 and the swing motion actuator 2252. The front connection frame 2237 according to an embodiment may be coupled to the side connection frame 2234 of the upper frame 2230. Accordingly, in a case in which the front connection frame 2237 is moved, the angle of the entire upper frame 2230 may be adjusted.

The massage module 2170 may be disposed on the upper frame 2230 according to an embodiment of the present invention.

The massage module 2170 may provide a dynamic stimulation to at least one among the head portion, the back portion, and the buttock portion of the user. The massage module 2170 may move upward or downward along the buttock frame 2231 and the back frame 2232.

Meanwhile, the conventional massage apparatus cannot adjust the angle between the buttock frame and the back frame since the buttock frame and the back frame are formed as one frame. Accordingly, the conventional massage apparatus has inconvenience in that the user needs to receive massage in the same posture. In addition, even if the conventional massage apparatus adjusts the angle between the buttock frame and the back frame, it is difficult for the massage module 2170 to move between the buttock frame and the back frame.

The massage apparatus 100 according to an embodiment of the present invention may adjust the angle between the buttock frame 2231 and the back frame 2232 by separating the buttock frame 2231 and the back frame 2232. In addition, since the massage apparatus 100 according to an embodiment of the present invention includes the guide module in the massage module 2170, it is possible to prevent the massage module 2170 from being separated between the buttock frame 2231 and the back frame 2232.

The buttock rack gear or the back rack gear may include a rack gear of a back-and-forth direction and a rack gear of a vertical direction. In the present invention, the back-and-forth direction refers to a direction heading from the massage module 2170 toward the user or from the user to the massage module 2170, and may also be referred to as a Z-axis direction.

The massage module 2170 may include a gear engaged with the buttock rack gear or the back rack gear. More specifically, the massage module 2170 may include gears respectively engaged with the rack gear of the back-and-forth direction and the rack gear of the vertical direction. The gears are rotated by the actuator disposed in the massage module 2170, so that the massage module 2170 may move forward, backward, upward, or downward.

As the massage module 2170 moves forward, the strength of massage may be increased. Moreover, as the massage module 2170 moves backward, the strength of massage may be decreased.

The rack gear may be formed of a metal material or a plastic material. For example, the rack gear may be made of iron, steel, alloy, reinforced plastic, melamine resin, phenol resin, or the like, but is not limited thereto.

FIGS. 2 and 3 illustrate a case in which the upper frame 2230 is a full-flat frame, but the present invention is not limited thereto. The upper frame 2230 may be formed in various shapes. For example, the upper frame 2230 may be one selected among an S frame, an L frame, an S&L frame, and a double S&L frame according to the shape of the upper frame, but is not limited thereto.

The S frame refers to a frame in which at least a portion of the upper frame 2230 has a curved shape like “S”. The L frame refers to a frame in which at least a portion of the upper frame 2230 is bent like “L”, the S&L frame refers to a frame having both of the curved shape like “S” and the bent shape like “L”, and the double S&L frame refers to a frame having the curved shape like “L” and the curved shape like “S” formed at two portions.

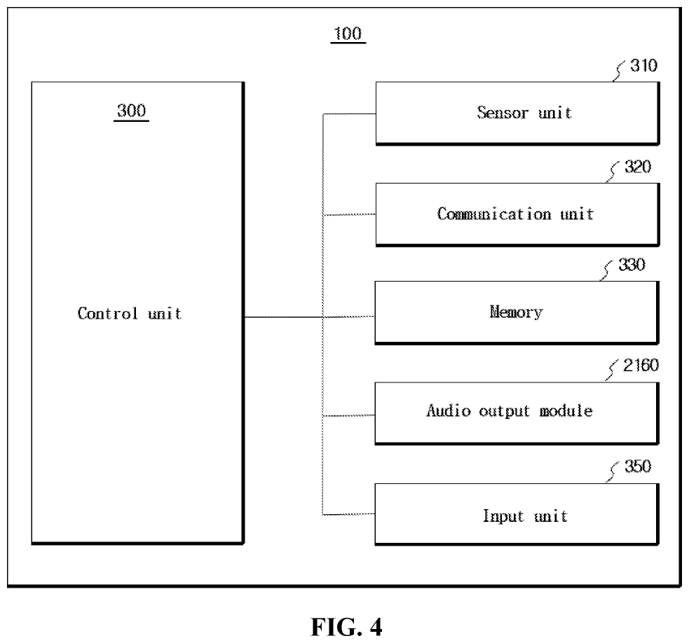

FIG. 4 is a view illustrating a massage apparatus according to an embodiment of the present invention.

The massage apparatus 100 may include at least one among a control unit 300, a sensor unit 310, a communication unit 320, a memory 330, an audio output unit 340, and an input unit 2180. The control unit 300 may include at least one processor and a memory. The at least one processor may perform instructions stored in the memory.

The control unit 300 may control the operation of the massage apparatus 100. The control unit 300 may include one processor or may include a plurality of processors. In a case in which the control unit 300 includes a plurality of processors, at least a portion of the plurality of processors may be physically spaced apart from each other. In addition, the massage apparatus 100 is not limited thereto and may be implemented in various ways.

According to an embodiment of the present invention, the control unit 300 may control the operation of the massage apparatus 100. For example, the massage apparatus 100 may include a plurality of actuators. The massage apparatus 100 may control the operation of the massage apparatus 100 by controlling the operation of the plurality of actuators. For example, the massage apparatus 100 may include at least one among a driving unit for moving an armrest frame support unit, a massage module moving actuator, at least one actuator included in the massage module, a back angle actuator, a leg angle actuator, a foot massage actuator, a leg length adjusting actuator, and a sliding actuator, and the control unit 300 may control the operation of the massage apparatus 100 by controlling them.

The massage module moving actuator is an actuator that enables vertical movement of the massage module 2170, and the massage module 2170 may move along the rack gear by the operation of the massage module moving actuator.

The back angle actuator is an actuator that adjusts an angle of a portion where the back of the user gets in contact with the massage apparatus 100, and the back angle of the massage apparatus 100 may be adjusted by the operation of the back angle actuator.

The leg angle actuator is an actuator for adjusting an angle of the leg massage unit 2300 of the massage apparatus 100. An angle between the leg massage unit 2300 and the body massage unit 2100 may be adjusted by the operation of the leg angle actuator.

The foot massage actuator is an actuator that operates the foot massage module included in the leg massage unit 2300. The massage apparatus 100 may provide foot massage to the user by using the foot massage actuator.

The massage module 2170 may include at least one actuator, and the control unit 300 may operate at least one actuator to provide various massage motions. For example, the control unit 300 may operate at least one actuator included in the massage module 2170 to provide a tapping massage, a kneading massage, and the like, and may provide various massage operations without being limited thereto.

The leg length adjusting actuator represents an actuator that adjusts the length of the leg massage unit 2300. For example, the control unit 300 may adjust the length of the leg massage unit 2300 to be suitable for the user by using the leg length adjusting actuator, and as a result, the user may receive massage suitable for the user's body shape.

The sliding actuator enables a sliding motion of the massage apparatus 100. For example, a horizontal base upper frame may move forward or backward by the operation of the sliding actuator, and as a result, the upper frame connected to the horizontal base upper frame may also move forward or backward.

The memory 330 may be included in the control unit 300 or may be located outside the control unit 300. The memory 330 may store various pieces of information related to the massage apparatus 100. For example, the memory 330 may include massage control information and personal authentication information, but is not limited thereto.

The memory 330 may be implemented through a non-volatile storage medium capable of continuously storing arbitrary data. For example, the memory 330 may include not only a disk, an optical disk, and a magneto-optical storage device, but also a storage device based on a flash memory and/or a battery-backup memory, but is not limited thereto.

The memory 330 may be a primary storage device, to which a processor directly accesses, like a random access memory (RAM), such as a dynamic random access memory (DRAM), a static random access memory (SRAM), or the like. The memory 330 may mean a volatile storage device in which stored information is instantaneously erased when power is turned off, but is not limited thereto. The memory 330 may be operated by the control unit 300.

The massage apparatus 100 may include a sensor unit 310. The sensor unit 310 may acquire various information using at least one sensor. The sensor unit 310 may be a sensor using a measurement means such as pressure, potential, and optics. For example, the sensor may include a pressure sensor, an infrared sensor, an LED sensor, a touch sensor, and the like, but is not limited thereto.

In addition, the sensor unit 310 may include a biometric information acquisition sensor. The biometric information acquisition sensor may acquire fingerprint information, face information, voice information, iris information, weight information, electrocardiogram information, body composition information, and the like, but is not limited thereto, and may include various pieces of biometric information.

According to another embodiment of the present invention, the massage apparatus 100 may sense a contact area and/or a contact position with the user through sensors. Furthermore, the massage apparatus 100 may provide a customized massage based on information acquired through sensors. In addition, the massage apparatus 100 may include a communication unit. The communication unit of the massage apparatus 100 may receive a signal from an external device. The control unit 300 may process the received signal to obtain a result signal. The communication unit may output the result signal to the external device.

The communication unit 320 may communicate with a module inside the massage apparatus 100, an external massage apparatus, and/or a user terminal through any type of network. The communication unit may include a wired/wireless access module for network access. The wireless access technology may include, for example, wireless LAN (WLAN) (Wi-Fi), wireless broadband (Wibro), world interoperability for microwave access (Wimax), high speed efficient downlink alliance (HSDPA), and the like. The wired access technology may include, for example, digital subscriber line (XDSL), fibers shop to the home (FTTH), power line communication (PLC), and the like. In addition, the network connection unit may include a short-range communication module to transmit and receive data to and from any device/terminal located at a short distance. For example, the short-range communication technology may include Bluetooth, radio frequency identification (RFID), infrared data security association (IrDA), ultra-wideband (UWB), ZigBee, and the like, but is not limited thereto.

Additionally, the massage apparatus 100 may further include an input unit 350 or an output unit. The massage apparatus 100 may receive an input from the user by using the input unit 350. In addition, the massage apparatus 100 may output the processed result of the control unit 300 to the output unit.

Specifically, the input unit 350 may receive a command related to the operation control of the massage apparatus 100 from the user, and the input unit 350 may be implemented in various forms. For example, the input unit 350 may be provided in the body massage unit 2100, or may be provided in the leg massage unit 2300, but is not limited thereto. Moreover, the input unit 350 may include a user input unit 2180, the massage apparatus control device 2200 of FIG. 1, or various external devices to be described referring to FIG. 4.

The massage apparatus 100 may acquire various commands from the user through the input unit 350. For example, the massage apparatus 100 may receive commands related to section of a massage module, selection of a massage type, selection of massage intensity, selection of massage time, selection of a massage area, selection of a position and an operation of the body massage unit 2100, selection of ON and OFF of power of the massage apparatus 100, selection of whether to operate a thermal function, selection related to sound reproduction, and the like, but is not limited thereto.

The massage apparatus 100 may provide an interface for selecting a massage mode. For example, the input unit 350 or the output unit may include a massage apparatus control device 2200. A medical massage list of various modes related to body improvement may be listed through the massage apparatus control device 2200.

The medical massage mode may include at least one among a concentration mode, a meditation mode, a recovery mode, a stretching mode, a sleep mode, a vital mode, a golf mode, a hip-up mode, an examinee mode, a gravity-free mode, and a growth mode.

According to another embodiment of the present invention, the input unit 350 may include buttons of a hot key type and/or selection buttons for selection, cancellation and input, according to preset user setting functions or preset self-setting functions.

The input unit 350 may be implemented as a keypad, a dome switch, a (static pressure type/capacitive) touch pad, a jog wheel, a jog switch, or the like, but is not limited thereto. Furthermore, the input unit 350 may obtain commands through the utterance of the user based on the voice recognition technology.

According to an embodiment of the present invention, the output unit may include a display for displaying an operation situation of the massage apparatus 100 or a current state of the user. In this case, the display may include at least one among a liquid crystal display (LCD), a thin film transistor-liquid crystal display (TFT-LCD), an organic light-emitting diode (OLED) display, a flexible display, and a three-dimensional (3D) display, but is not limited thereto.

The output unit may include an audio output unit 340. The audio output unit 340 may provide a user with an audio output of any form. For example, the audio output unit 340 may output a sound source and/or a binaural beat optimized for a massage pattern provided by the massage apparatus 100 to the user, thereby providing a brain stimulation to the user. The audio output unit 340 may output a sound signal received through a network (not illustrated) or stored in an internal/external storage medium (not illustrated). For example, the audio output unit 340 may output a sound source according to the control of the user terminal through a network connection (e.g., Bluetooth connection, etc.) with the user terminal. Additionally, the audio output unit 340 may output a sound signal generated in relation to the operation of the massage apparatus 100.

It will be appreciated by those skilled in the art that the present invention may be implemented in combination with other program modules and/or through a combination of hardware and software. For example, the present invention may be implemented by a computer-readable medium.

Any of media accessible by a computer may be a computer-readable medium. Such a computer-readable medium may include a volatile medium, a non-volatile medium, a transitory medium, a non-transitory medium, a movable medium, and an unmovable medium. For example, the computer-readable medium may include a computer-readable storage medium and a computer-readable transmission medium.

The computer-readable storage medium includes a volatile medium, a non-volatile medium, a transitory medium, a non-transitory medium, a movable medium, and an unmovable medium implemented by computer-readable commands, a data structure, a program module, or a method or technology for storing information like data. The computer-readable storage medium includes a memory technology, such as a RAM, a ROM, an EEPROM, a flash memory or the like, a magnetic storage device, such as a CD-ROM, a digital video disk (DVD) or the like, a magnetic storage device, such as a magnetic cassette, a magnetic tape, a magnetic disk storage or the like that can be accessed by a computer and that can be used to store desired information, but is not limited thereto.

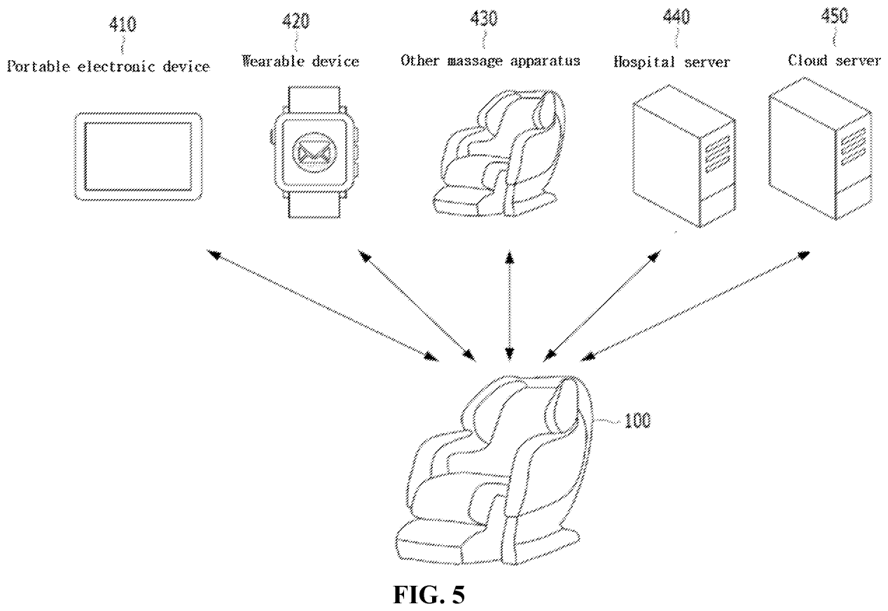

FIG. 5 is a view illustrating an external device capable of communicating with the massage apparatus 100 according to an embodiment of the present invention.

The massage apparatus 100 may communicate with an external device in a wired or wireless manner to transmit and receive various data.

The external device may include a portable electronic device 410, such as an AI speaker, a tablet, or a smartphone. The portable electronic device 410 may be only for the massage apparatus 100 or may be a general-purpose portable electronic device. In addition, the external device may include a wearable device 420 such as a smart watch or a smart band. The external device may not include the massage apparatus 100 currently used by the user but other massage apparatus 430. The external device may include a hospital server 440. The external device may include a personal health record (PHR) server. Furthermore, the external device may include a cloud server 450. The external device may include a medical measurement device, such as an electronic scale, a blood glucose monitoring device, or a blood pressure meter.

Although some examples of the external device are described in the present invention, it should be understood that all kinds of devices capable of communicating with the massage apparatus 100 and sending and receiving information with the massage apparatus 100 in a wired or wireless manner may be included in an external device.

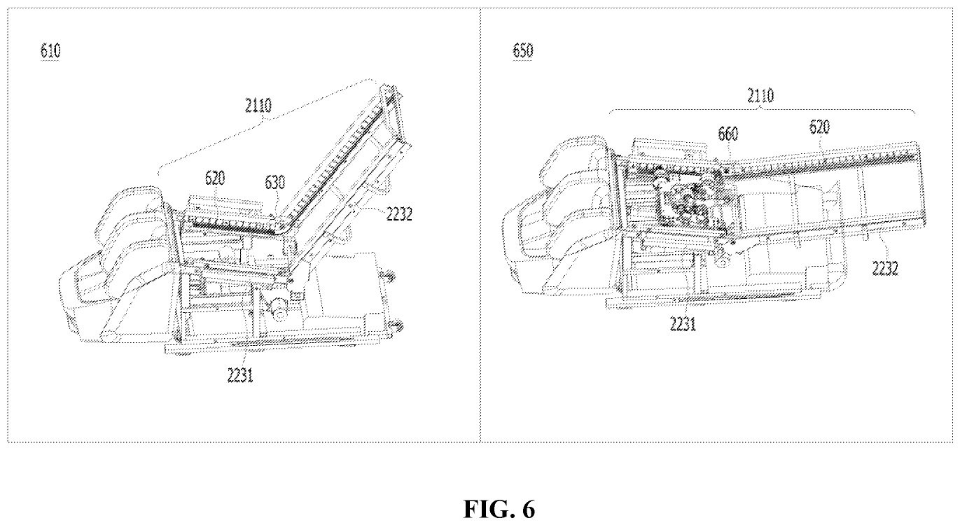

FIG. 6 is a view illustrating a massage apparatus according to an embodiment of the present invention.

The drawing 610 of FIG. 6 may correspond to FIG. 2. Additionally, the drawing 650 of FIG. 6 may correspond to FIG. 3.

Referring to FIG. 6, the massage apparatus 100 may include a rack gear 620. More specifically, the main frame 2110 may include a rack gear 620 for moving the massage module 2170. The rack gear 620 may be coupled to the main frame 2110.

As illustrated in the drawing 610 of FIG. 6, in a case in which the back frame 2232 of the massage apparatus 100 is erect, a portion 630 of the rack gear 620 may be folded. In addition, as illustrated in the drawing 650 of FIG. 6, in a case in which the back frame 2232 of the massage apparatus 100 is laid down, a portion 660 of the rack gear 620 may be relatively unfolded.

As described above, the rack gear 620 may include a buttock rack gear and a back rack gear. The buttock rack gear and the back rack gear may not be rack gears separated from each other. The buttock rack gear refers to a rack gear coupled to the buttock frame 2231, and the back rack gear may refer to a rack gear coupled to the back frame 2232. That is, the buttock rack gear and the back rack gear may be named depending on the position of one rack gear. That is, the buttock rack gear and the back rack gear may be one rack gear 620 formed without a connection unit.

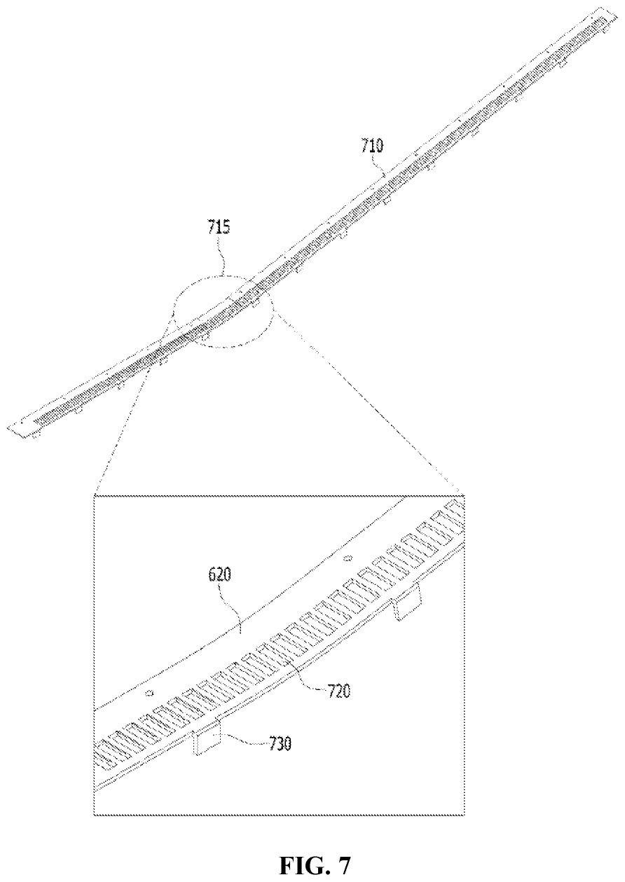

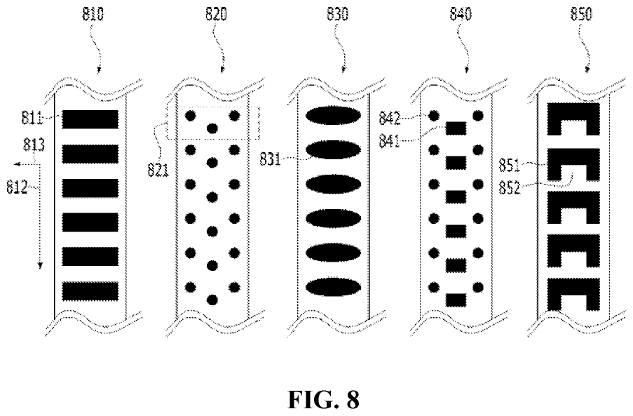

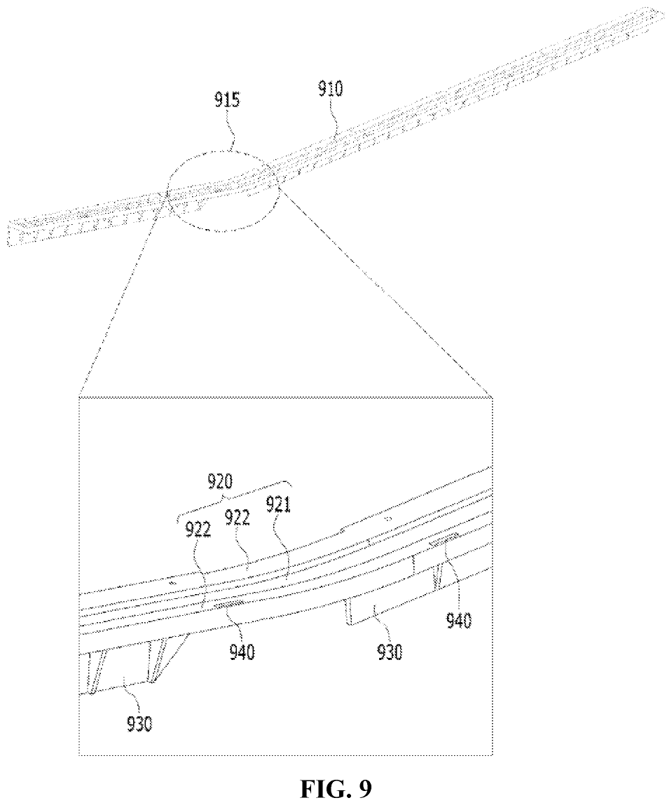

The rack gear 620 may be formed of a flexible material. Accordingly, the rack gear 620 may be folded as illustrated in the drawing 610 of FIG. 6, and may be spread flat as illustrated in the drawing 650 of FIG. 6. The rack gear 620 may include a rack gear belt and a rack gear support. The rack gear belt is described below in conjunction with FIGS. 7 and 8, and the rack gear support is described in conjunction with FIG. 9.

FIG. 7 is a view illustrating a rack gear belt included in a rack gear according to an embodiment of the present invention.

The rack gear 620 may include a rack gear belt 710. The rack gear belt 710 may have a plurality of holes 720 formed therein. The shape of the hole may vary. The shape of the plurality of holes may be any one among a rectangle, a rhombus, a square, an oval, or a circle. The shape of the hole may be a polygon such as a triangle, a rectangle, or a hexagon. In addition, the shape of the hole may be circular or oval. The holes may be formed in plural, and at least one hole may be included in one rack gear belt 710. A pinion gear of the massage module 2170 may be engaged with the hole of the rack gear belt 710.

At least a portion of the rack gear belt 710 may be a flexible material. The folded portion 715 of the rack gear belt 710 may be made of a flexible material. The rack gear belt 710 may be made of spring steel. Accordingly, in a case in which the back frame 2232 is folded or unfolded with respect to the buttock frame 2231, the rack gear belt 710 may also be folded or unfolded.

The rack gear belt 710 may extend along the buttock frame 2231 and the back frame 2232 included in the main frame 2110. That is, referring to FIG. 6, the rack gear belt 710 of the rack gear 620 may be formed along the main frame 2110.

Referring to FIG. 7, the rack gear belt 710 may include a fixing hook 730. The fixing hook 730 may be configured to couple the rack gear belt 710 to the rack gear support.

FIG. 8 is a view illustrating a rack gear belt included in a rack gear according to an embodiment of the present invention.

The rack gear belt may include various shapes of holes. Hereinafter, various shapes of holes of the rack gear belt will be described. The massage module 2170 may include a pinion gear suitable for the hole formed in the rack gear belt.

The rack gear belt 810 may include a rectangular hole 811. The hole 811 may have a polygonal shape, such as a hexagon, or a quadrangle. Moreover, the hole 811 may be circular or oval. The hole 811 may be continuously formed in a longitudinal direction 812 of the rack gear belt 810. In a case in which the rack gear belt 810 has a quadrangular shape, the rack gear belt 810 may be easily implemented, and may be easily engaged with the pinion gear.

The rack gear belt 820 may include a circular hole. A basic pattern 821 of the hole may be repeated on the rack gear belt 820 in the longitudinal direction 812. The basic pattern 821 of the hole may include a plurality of holes. The rack gear belt 820 may be forced by a pinion gear of the massage module 2170. In a case in which the area of the hole is minimized like the rack gear belt 820, deformation of the rack gear belt 820 may be reduced, and durability may be increased.

At least one hole among the plurality of holes may be formed in the basic pattern 821 in a width direction 813 of the rack gear belt. In addition, the plurality of holes may be continuously formed at a predetermined pitch in the longitudinal direction 812 of the rack gear belt. That is, the plurality of holes may have at least one row and at least one column on the rack gear belt 820.

The rack gear belt 830 may include an oval hole 831. The hole 831 may be continuously formed in the longitudinal direction 812 of the rack gear belt 810. In a case in which the hole is sharp, stress may be increased at the pointed portion. In addition, a portion having a high stress is easily torn. However, in a case in which the hole 831 is rounded like the rack gear belt 830, there is no pointed part, thereby increasing durability of the rack gear belt 830.

The rack gear belt 840 may include a square hole 841 and a circular hole 842, but is not limited thereto. The rack gear belt 840 may be formed by combining holes of various shapes. Both sides of the rack gear belt may be more vulnerable to an external force than the central portion. In a case in which the sharp hole is placed at both sides, durability of the rack gear belt may be further lowered. Therefore, circular holes 842 may be formed at both sides of the rack gear belt 840, and a square hole may be formed in the central portion to increase durability.

The rack gear belt 850 may include a polygonal hole 851. The hole 851 may be continuously formed in the longitudinal direction 812 of the rack gear belt 810. The polygonal hole 851 may include a protrusion 852. In a case in which the rack gear belt 850 is folded by the movement of the back frame 2232, the protrusion 852 is folded relatively less, thereby widening the area of the hole 851. That is, in a case in which the rack gear belt 850 is folded, the area of the hole 851 is relatively reduced, so that the gear teeth of the massage module 2170 and the hole 851 may not be engaged with each other. The rack gear belt 850 includes a polygonal hole 851. Since the width of the hole is increased even if the rack gear belt 850 is folded, the gear teeth of the massage module 2170 and the hole 851 can be effectively engaged with each other.

FIG. 9 is a view illustrating a rack gear support included in a rack gear according to an embodiment of the present invention.

The rack gear 620 of the massage apparatus 100 may include a rack gear support 910. The rack gear support 910 may be configured to support the rack gear belt 710. Additionally, the rack gear support 910 may be disposed under the rack gear belt 710. However, the rack gear support 910 is not limited thereto, and may be positioned above the rack gear belt 710. At least a portion of the rack gear support 910 may be made of a flexible material. For example, a folded portion 915 of the rack gear support 910 may be made of a flexible material. Accordingly, in a case in which the back frame 2232 is folded or unfolded with respect to the buttock frame 2231, the rack gear support 910 may also be folded or unfolded.

The rack gear support 910 may include a support core 920 that supports the rack gear belt 710 above or below. The support core 920 may include a gear tooth movement groove 921 formed toward the pinion gear so that teeth of the pinion gear do not get in contact with the rack gear support 910. In addition, a portion of the support core 920, in which the tooth movement groove 921 is not formed, may be referred to as a gear support 922. Since the rack gear support 910 includes the gear tooth movement groove 921, the rack gear support 910 may have a cross-section of a ‘ [symbol] ’ shape.

In addition, at least a portion of the rack gear support 910 may include a side plate 930. The side plate 930 may be substantially perpendicular to the support portion core 920. In addition, the side plate 930 may prevent bending of the support portion core 920. The side plate 930 may prevent deformation of the rack gear support 910 to firmly support the rack gear belt 710. The side plate 930 may not be formed on the folded portion 915 of the rack gear support 910. The folded portion 915 of the rack gear support 910 may mean a portion other than the buttock rack gear or the back rack gear. As described above, the buttock rack gear is a portion of the rack gear 620, which is coupled to the buttock frame 2231, and the back rack gear may be a portion of the rack gear 620, which is coupled to the back frame 2232. In a case in which the back frame 2232 is folded or unfolded with respect to the buttock frame 2231, the rack gear support 910 on which the side plate 930 is not formed may be folded or unfolded.

The rack gear support 910 may include at least one hook groove 940. As described above, the rack gear belt 710 may include at least one fixing hook 730. The at least one fixing hook 730 may be inserted into and fixed to the at least one hook groove 940, and the rack gear belt 710 may be fixed to the rack gear support 910.

The folded portion 915 of the rack gear support 910 may include an angle change unit. The angle change unit may be configured to be folded so that the angle of the back rack gear with respect to the buttock rack gear can be changed.

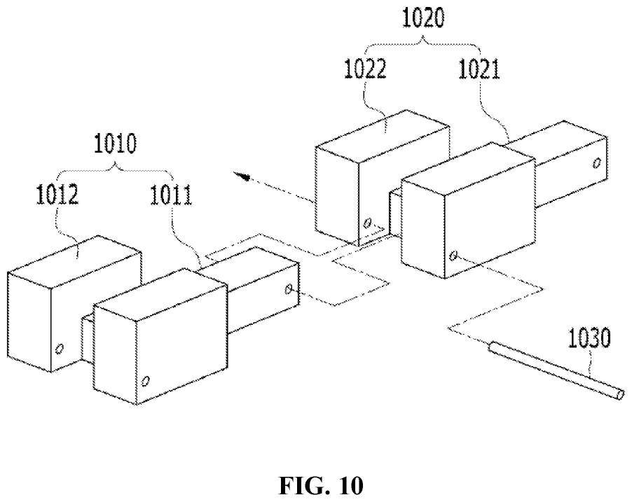

FIG. 10 is a view illustrating an angle change unit according to an embodiment of the present invention.

The angle change unit may include a first sub-component 1010, a second sub-component 1020, and a change unit rotating shaft 1030 passing through both the first sub-component and the second sub-component. The change unit rotating shaft 1030 may pass through a hole formed in a tooth movement portion 1011 of the first sub component 1010 and a hole formed in a tooth movement portion 1021 of the second sub component 1020. The first sub-component 1010 and the second sub-component 1020 may rotate around the change unit rotating shaft 1030. That is, the first sub-component 1010, the second sub-component 1020, and the change unit rotating shaft 1030 may be used at the folded portion of the rack gear support 910, so that the rack gear support 910 may be folded.

The first sub-component 1010 and the second sub-component 1020 may respectively have the tooth movement portions 1011 and 1021 formed to be lower than the gear supports 1012 and 1022 so that the teeth of the pinion gear do not contact. In addition, the first sub-component 1010 and the second sub-component 1020 may respectively include gear supports 1012 and 1022 as well as the tooth movement grooves 1011 and 1021.

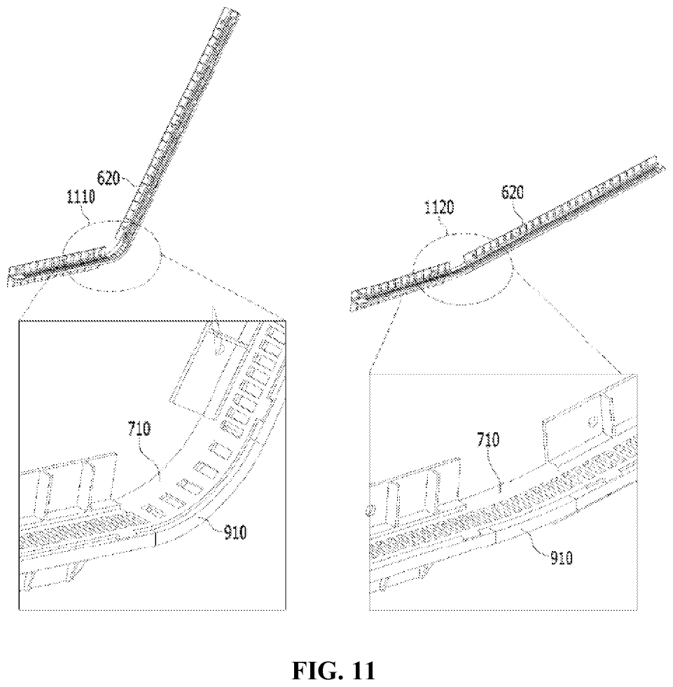

FIG. 11 is a view illustrating a rack gear according to an embodiment of the present invention.

The rack gear 620 may include a rack gear belt 710 and a rack gear support 910. The rack gear belt 710 may be coupled to the rack gear support 910 when at least one fixing hook 730 of the rack gear belt 710 and at least one hook groove 940 of the rack gear support 910 are coupled to each other.

The rack gear belt 710 and the at least a portion of the rack gear support 910 may be made of a flexible material. In addition, as illustrated in FIG. 10, the at least a portion of the rack gear support 910 may include a first sub-component 1010 and a second sub-component 1020 to have a foldable structure.

The rack gear 620 may be bent or stretched as the angle between the buttock frame 2231 and the back frame 2232 is adjusted. A marked portion 1110 of FIG. 11 illustrates that the rack gear 620 is bent. A marked portion 1120 of FIG. 11 illustrates that the rack gear 620 is stretched. The folded portion of the rack gear belt 710 included in the rack gear 620 may be formed integrally. That is, the rack gear belt 710 may be bent or stretched by elasticity of the material itself, and an additional folding may not be used to fold the rack gear belt 710. The present invention does not need a complex assembly process to make the rack gear belt 710, thereby improving a production speed of the rack gear belt 710. In addition, even if the rack gear belt 710 is folded, the pitch between the plurality of holes 720 formed in the rack gear belt 710 may be maintained constant. Accordingly, there may be no phenomenon in which the pinion gear of the massage module 2170 runs idle over the rack gear belt 710.

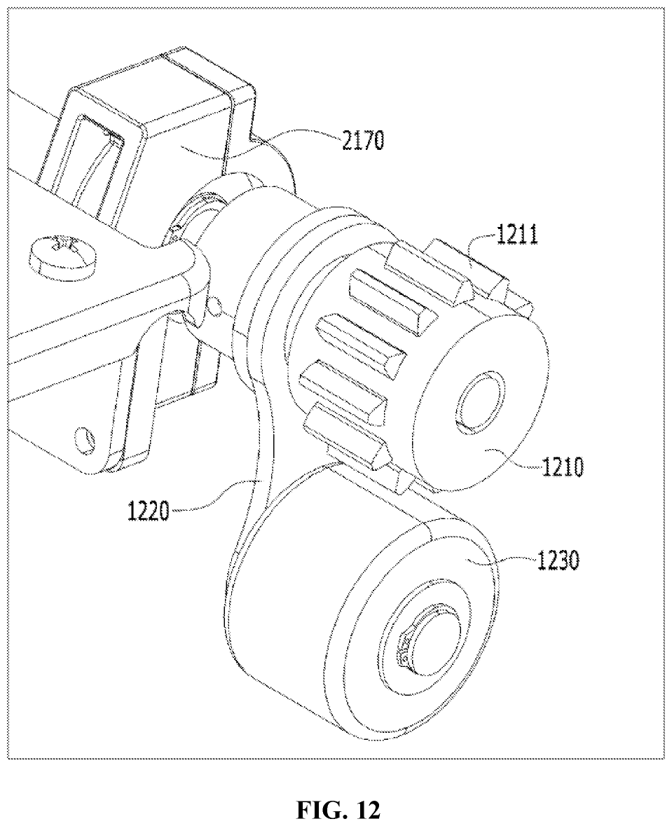

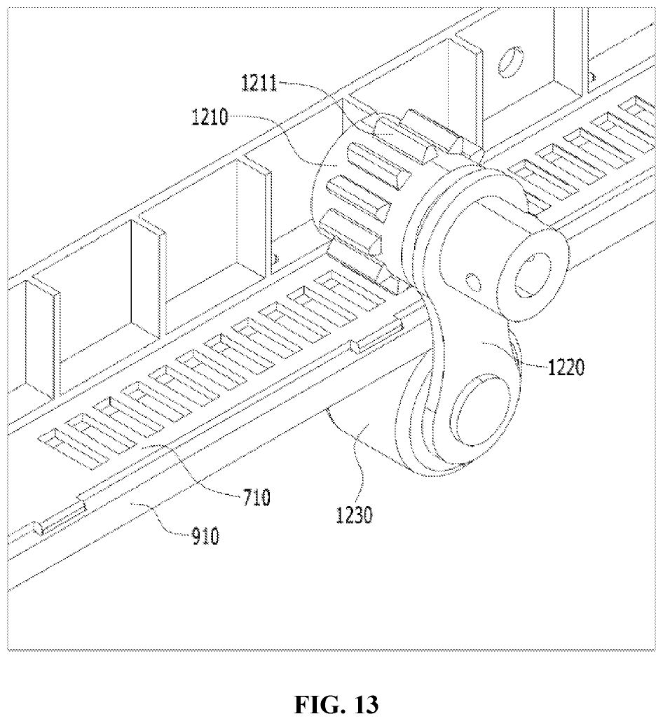

FIG. 12 illustrates a pinion gear included in a massage module according to an embodiment of the present invention. FIG. 13 is a view illustrating a pinion gear included in a massage module according to an embodiment of the present invention.

FIG. 13 is a view of the pinion gear 1210 of FIG. 12 when viewed from the opposite direction. Hereinafter, referring to FIGS. 12 and 13, the pinion gear included in a massage module according to an embodiment of the present invention will be described.

The massage module 2170 may include a pinion gear 1210. The pinion gear 1210 may include teeth 1211 engaged with the rack gear belt 710. The pinion gear 1210 may move the massage module along the rack gear by rotation received from the actuator. The massage module 2170 may include a connection link 1220 connecting the pinion gear 1210 and the guide roller 1230.

The massage module 2170 may include a guide roller 1230. The guide roller may be at least one. The guide roller 1230 may be rotated by being in contact with the rack gear support 910 by the movement of the pinion gear 1210 because of a friction force between the guide roller 1230 and the rack gear support 910. The guide roller 1230 may prevent shaking of the massage module 2170. The guide roller 1230 may prevent the pinion gear 1210 from being separated from the rack gear belt 710. In particular, in a case in which the number of guide rollers is two, shaking of the massage module 2170 may be effectively prevented, and the pinion gear 1210 may be effectively prevented from being separated from the rack gear belt 710.

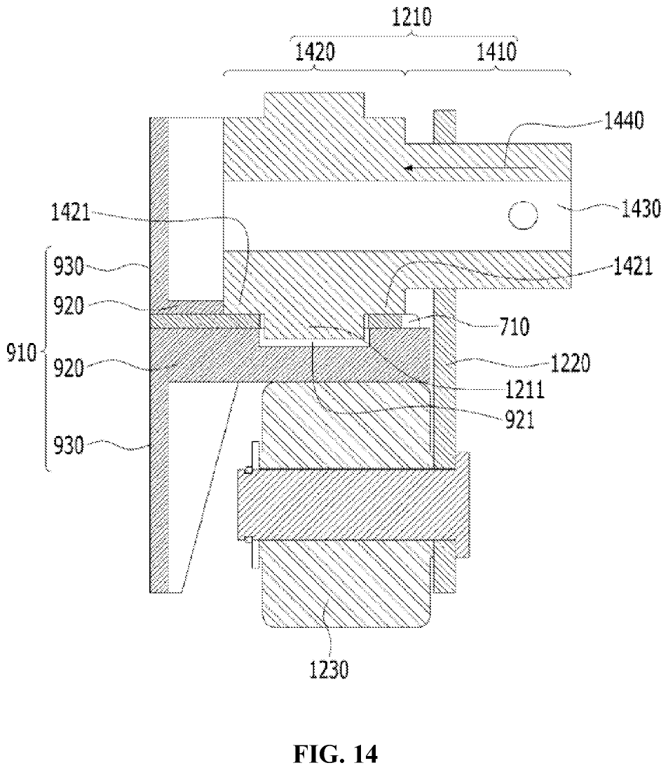

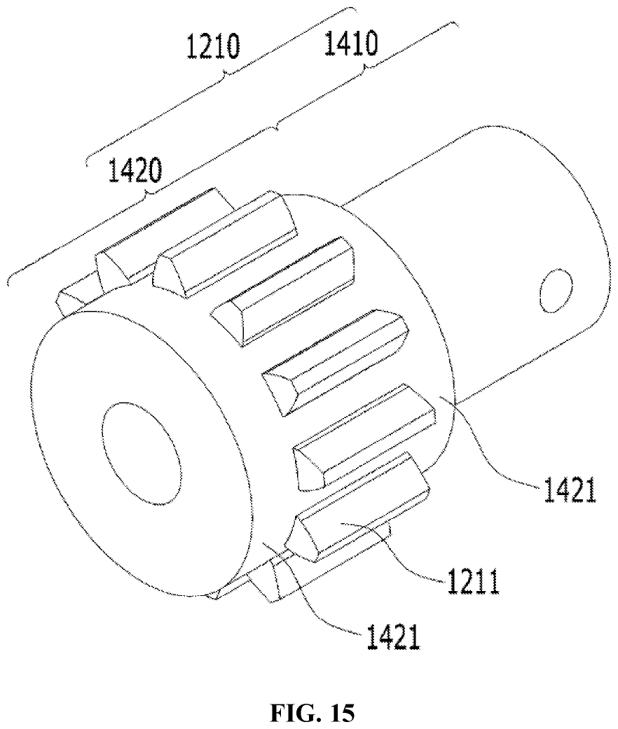

FIG. 14 is a view for depicting a pinion gear according to an embodiment of the present invention. FIG. 15 is a view for depicting a pinion gear according to an embodiment of the present invention.

First, referring to FIG. 14, the rack gear support 910 may include a support core 920 and a side plate 930. The support core 920 may include a gear tooth movement groove 921 formed toward the pinion gear so that teeth 1211 of the pinion gear do not get in contact with the support portion 910.

Referring to FIGS. 14 and 15, the pinion gear 1210 may include a driving shaft insertion groove 1430 into which a driving shaft for transmitting the rotation of the actuator is inserted. The pinion gear 1210 may include a link insertion portion 1410 inserted into a connection link. The pinion gear 1210 may include a gear head 1420. The gear head 1420 may extend from the link insertion portion 1410 in the longitudinal direction 1440 of the driving shaft. Moreover, the teeth 1211 of the pinion gear may be formed on at least a portion of the outer circumferential surface of the gear head 1420. As described above, the teeth 1211 of the pinion gear may be engaged with a plurality of holes formed in the rack gear belt 710.

The gear head 1420 may include a roller portion 1421 on which the teeth 1211 of the pinion gear are not formed. The roller portion 1421 may be formed at both sides of the tooth 1211 of the pinion gear. The roller portion 1421 may touch a portion where the at least one hole is not formed in the rack gear belt 710. Furthermore, the pinion gear 1210 may be supported from the rack gear belt 710 by the roller unit 1421. More specifically, the roller portion 1421 may receive a force from the rack gear support part 910 and the rack gear belt 710. Accordingly, the pinion gear 1210 may apply excessive force to the rack gear belt 710 to prevent the rack gear belt 710 from being damaged.

The roller portion 1421 of the gear head 1420 may be surface-treated to increase a frictional force. That is, the outer circumferential surface of the roller portion 1421 may have a rough surface. Alternatively, the outer circumferential surface of the roller unit 1421 may be made of a material capable of rotating without slipping by getting in close contact with a portion of the rack gear belt 710 where there is no hole, such as rubber or silicone.

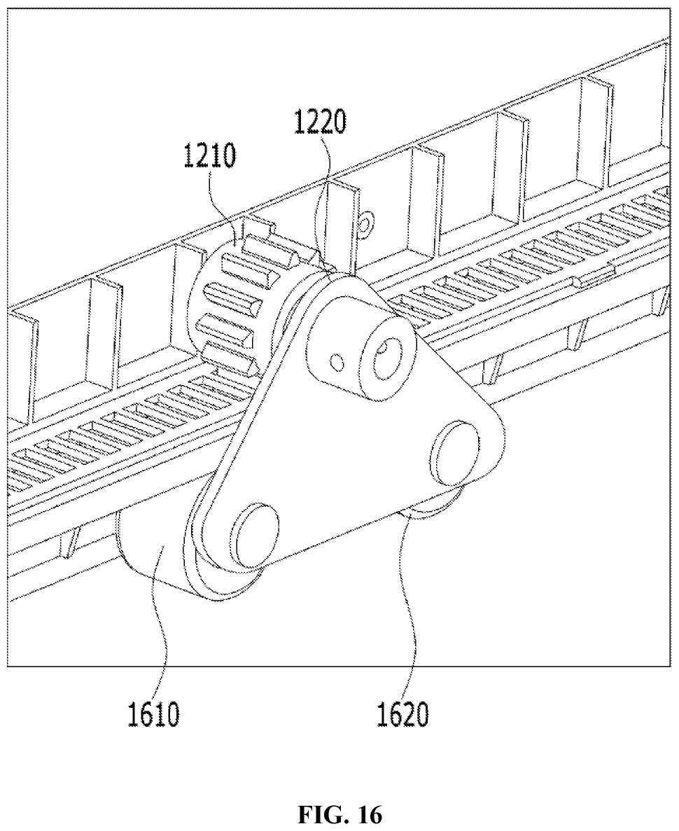

FIG. 16 is a view illustrating a pinion gear and a guide roller of a massage module according to an embodiment of the present invention.

The guide roller may include at least two guide rollers. That is, the massage module 2170 may include a first guide roller 1610 and a second guide roller 1620. In a case in which the first guide roller 1610 and the second guide roller 1620 are included, the pinion gear 1210 may more stably move on the rack gear belt 710 without shaking.

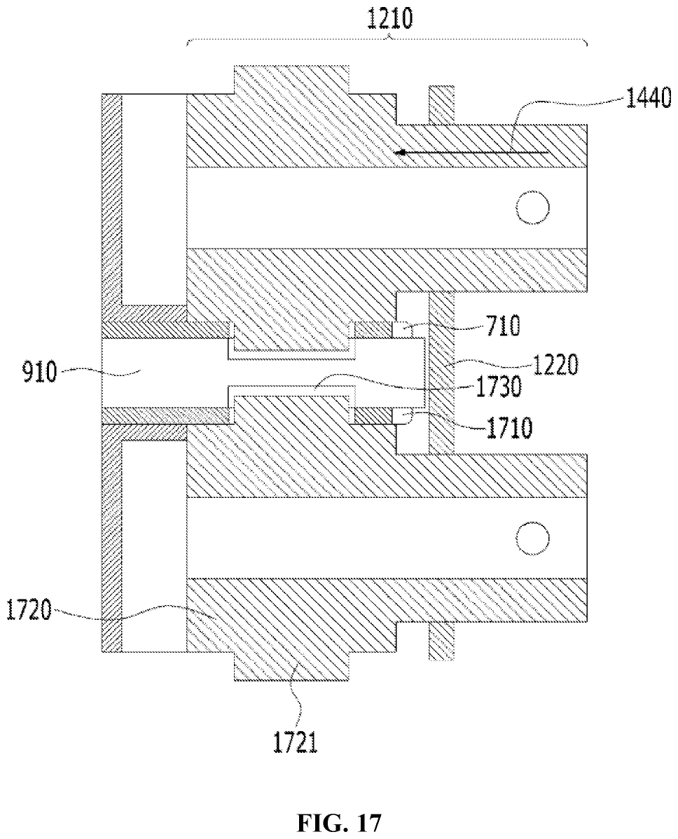

FIG. 17 is a view illustrating a massage module according to an embodiment of the present invention.

The massage apparatus 100 may further include an additional rack gear belt 1710. The additional rack gear belt 1710 may be located below the rack gear support 910. The additional rack gear belt 1710 may include a plurality of holes. The additional rack gear belt 1710 is made of a flexible material, and may extend along the buttock frame and the back frame included in the main frame.

At least a portion of the guide roller 1720 may have gear teeth 1721. The gear teeth 1721 of the guide roller 1720 may engage the additional rack gear belt 1710. The guide roller 1720 may allow the massage module 2170 to move along the rack gear 620 by rotation received from the actuator.

The rack gear support 910 may include a gear tooth movement groove 1730 toward the guide roller 1720 so that the gear teeth 1721 formed toward the guide roller 1720 are not in contact with the guide roller 1720.

The gear teeth 1721 formed on the guide roller 1720 may effectively prevent the pinion gear from being separated from the rack gear.

As described above, the rack gear 620 included in the massage apparatus 100 has been described. The rack gear 620 of the present invention may be manufactured simply and have high durability. The conventional art has several problems in that the rack gear is folded while the back frame 2232 and the buttock frame 2231 are folded, and in that a distance between teeth of the rack gear changes. In a case in which the distance between teeth of the rack gear is reduced or increased, the pinion gear of the massage module may run idle. However, since the distance between teeth of the rack gear 620 according to the present invention is not changed, the massage module 2170 may stably move by the pinion gear.

Various embodiments according to the present invention have been described. It will be understood by those skilled in the art that the present invention may be implemented in a modified form without departing from the essential characteristics of the present invention. Therefore, the disclosed embodiments should be considered in the expository perspective rather than limitative perspective. Therefore, the scope of the present invention is defined not by the detailed description of the invention but by the appended claims, and all differences within the equivalent scope will be construed as being included in the present invention.

Meanwhile, embodiments of the present invention described above may be made as a computer-executable program, and may be implemented in a general-purpose digital computer that operates the program using a computer-readable recording medium. The computer-readable recording medium includes a storage medium, such as a magnetic storage medium (e.g., a ROM, a floppy disk, a hard disk, etc.), or an optical recording medium (e.g., a CD-ROM, a DVD, etc.).

1. A massage apparatus comprising:
a rack gear included in a main frame to move a massage module,
wherein the rack gear comprises:
a buttock rack gear and a back rack gear without a connection unit for connecting the buttock rack gear and back rack gear;
a rack gear belt having a plurality of holes, made of a flexible material, and extending along a buttock frame and a back frame included in the main frame; and
a rack gear support positioned below the rack gear belt to support the rack gear belt and made of a flexible material,
wherein the massage module comprises:
a pinion gear having teeth engaging the rack gear belt, and moving the massage module along the rack gear by rotation received from an actuator;
a connection link for connecting the pinion gear and a guide roller; and
a guide roller rotating in contact with the rack gear support by the movement of the pinion gear, and preventing the massage module from shaking.

2. The massage apparatus according to claim 1, wherein the rack gear support comprises:
a support core supporting the rack gear belt above or below; and
a side plate being perpendicular to the support core, preventing the support core from being bent, and formed on at least a portion of the rack gear support.

3. The massage apparatus according to claim 2, wherein the support core comprises:
a gear tooth movement groove formed toward the pinion gear side so that teeth of the pinion gear do not get in contact with the rack gear support; and
at least one hook groove to which at least one fixing hook formed on the rack gear belt is coupled so that the rack gear belt can be fixed to the rack gear support.

4. The massage apparatus according to claim 3, wherein the pinion gear comprises:
a driving shaft insertion groove into which a driving shaft for transmitting rotation of the actuator is inserted;
a link insertion portion inserted into a connection link; and
a gear head extending from the link insertion portion in a longitudinal direction of the driving shaft and having teeth formed on at least a portion of the outer circumferential surface thereof.

5. The massage apparatus according to claim 4, wherein a portion of the gear head where the teeth of the pinion gear are not formed at both sides of the tooth of the pinion gear touches a portion of the rack gear belt where at least one hole is not formed, and the pinion gear is supported from the rack gear belt.

6. The massage apparatus according to claim 4, wherein a portion of the gear head where the teeth of the pinion gear are not formed at both sides of the tooth of the pinion gear is surface-treated to increase a frictional force.

7. The massage apparatus according to claim 1, wherein one or more guide rollers are connected to the pinion gear by the connection link.

8. The massage apparatus according to claim 1, wherein the shape of the plurality of holes formed in the rack gear belt is any one of a rectangular shape, an oval shape, and a circular shape, and
wherein at least one of the plurality of holes is formed in a width direction of the rack gear belt, and the plurality of holes are continuously formed at a predetermined pitch in a longitudinal direction of the rack gear belt.

9. The massage apparatus according to claim 1, wherein the rack gear belt is made of spring steel.

10. The massage apparatus according to claim 1, further comprising:
an additional rack gear belt which is positioned below the rack gear support part, has a plurality of holes, is made of a flexible material, and extends along the buttock frame and the back frame included in the main frame,
wherein at least a portion of the guide roller has gear teeth to be engaged with the additional rack gear belt, and the guide roller moves the massage module along the rack gear by rotation received from the actuator, and
wherein the rack gear support includes a gear tooth movement groove formed toward the guide roller so as not to get in contact with the gear teeth formed on the guide roller.

11. The massage apparatus according to claim 1, wherein the rack gear support includes an angle change unit to change an angle of the back rack gear with respect to the buttock rack gear, and
wherein the angle change unit includes a first sub-component, a second sub-component, and a change unit rotating shaft passing through both the first sub-component and the second sub-component.

12. The massage apparatus according to claim 2, wherein the side plate is not formed between the buttock rack gear and the back rack gear.
